(19) United States
(12) Patent Application Publication
(10) Pub. No.: US 2024/0343584 A1
(43) Pub. Date: Oct. 17, 2024

(54) EXFOLIATION AND DISPERSION OF CARBON NANOTHREADS

(71) Applicant: The Penn State Research Foundation, University Park, PA (US)

(72) Inventors: George Bepete, University Park, PA (US); Sikai Wu, University Park, PA (US); Yu Lei, University Park, PA (US); Nestor Perea Lopez, University Park, PA (US); Vincent Henry Crespi, University Park, PA (US); Mauricio Terrones, University Park, PA (US)

(21) Appl. No.: 18/701,074

(22) PCT Filed: Nov. 2, 2022
(86) PCT No.: PCT/US22/79133

§ 371 Date: Apr. 12, 2024

Related U.S. Application Data
(60) Provisional application No. 63/263,471, filed on Nov. 3, 2021.

(51) Int. Cl. C01B 32/18

(52) U.S. Cl. CPC C01B 32/18; C01P 2002/72; C01P 2002/82; C01P 2002/84; C01P 2002/85; C01P 2002/88; C01P 2004/16; C01P 2006/22; C01P 2006/40; C01P 2006/60

(57) ABSTRACT

Embodiments relate to organic and aqueous dispersions of exfoliated bundles and individualized carbon nanothreads, and a method for making the dispersions. Embodiments involve reducing carbon nanothread crystals by an alkali metal or a mixture of alkali metals to form a carbon nanothread alkali metal compound. The carbon nanothread alkali metal compounds can be spontaneously soluble in polar aprotic organic solvents to form stable carbon nanothread dispersions. The dispersions and methods of making the same can be used for preparing carbon nanothread films for electronic devices, electrocatalytic electrodes, sensing devices and carbon nanothread/polymer nanocomposites.

### CROSS-REFERENCE TO RELATED APPLICATIONS

This patent application is related to and claims the benefit of priority of U.S. 63/263,471, filed on Nov. 3, 2021, the entire contents of which is incorporated by reference.

### STATEMENT REGARDING FEDERALLY SPONSORED RESEARCH OR DEVELOPMENT

This invention was made with government support under Grant No. CHE1832471 awarded by the National Science Foundation. The Government has certain rights in the invention.

### FIELD OF THE INVENTION

The present disclosure relates to the field of carbon nanomaterials, specifically carbon nanothreads. The present disclosure is also related to dispersions containing carbon nanothreads. In addition, the present disclosure is related to the field of materials and devices that contain carbon nanothreads. The present disclosure is also related to processes and applications of carbon nanothread dispersions, especially for preparing nanothread films for electronic devices, electrocatalytic electrodes, sensing devices and carbon nanothread/polymer nanocomposites and the purification of carbon nanothreads.

### BACKGROUND OF THE INVENTION

Carbon nanothreads are a type of ultrathin one-dimensional carbon nanomaterial consisting of a strong sp³-bonded carbon core surrounded by hydrogen atoms. The production of carbon nanothreads can be done through pressure-induced solid-state reaction along one-dimensional columns of multi-unsaturated precursor molecules, such as benzene.¹ Individual carbon nanothreads have diameters ranging from several to tens of angstroms, depending on the precursor of choice, and typically longer than a few nanometers in length. The smallest individual carbon nanothread, cubane-derived nanothread, has a diameter of only 0.2 nm.²

Detailed characterization of nanothread samples show that they are composed of an sp³ carbon backbone, and a variable fraction of unsaturated sp² carbon bonds.³ Carbon nanothreads are considered materials that have great advantages, given their extraordinary mechanical strength, highly programable chemical compositions, and readily tunable structures and properties.^{4,5}

The doping and incorporation of heteroatoms is expected to effectively modify the chemical and electronic properties of nanothreads that allow for application as photocatalysts, electron emitters, chemical sensors, or possibly superconductors. The doping and incorporation of heteroatoms such as nitrogen, oxygen, sulfur and boron into the nanothread backbone is possible by employing aromatic precursor molecules containing these heteroatoms such as pyridine, furan, thiophene, or boron containing aromatics during synthesis.⁶ Functional groups can be attached to the backbone of nanothreads with controlled orientation and distance between them by employing derivatives of aromatic hydrocarbon molecules such as 1,4-dicyanobenzene.⁷

The experimental synthesis, characterization, and theoretical studies of expected useful applications of carbon nanothreads has been a fertile area of research for over 5 years, beginning with the discovery of benzene-derived carbon nanothreads in 2014 by the Badding group at Penn State.¹ Shortly thereafter, this and several other groups reported on the synthesis of carbon nanothreads incorporating heteroatoms in the carbon backbone and functional groups attached to the carbon backbone.⁷⁻⁹

Fully saturated benzene-derived carbon nanothreads are insulators with a band gap that is typically greater than 4.0 eV. The incorporation of heteroatoms such as N, O, and S within the main carbon framework of nanothreads, as well as unsaturated sp² carbon in partially saturated carbon nanothreads, can reduce the band gap to 1.8 eV. The decrease in band gap is attributed to the lowering of the HOMO-LUMO gap by the heteroatoms incorporated into the carbon nanothread structure.^{4,8} Several theoretical studies have proposed useful applications of carbon nanothreads in various fields such as polymer nanocomposites, carbon fibers, energy storage and electronic devices.¹⁰⁻¹³

Carbon nanothreads are synthesized by compressing multi-unsaturated organic precursors to typically, 15-25 GPa, at room temperature, followed by decompression to retrieve the reaction product. The required pressure can be lowered by utilizing precursor molecules with reduced aromaticity and/or applying elevated reaction temperature which may also improve product yield.^{8,14} The resulting carbon nanothreads assume a 2D crystalline close-packing of the nanothreads (bundling), hundreds of micrometers across, due to the high attractive van der Waals (vdW) forces between adjacent nanothreads.¹⁵ Studies have shown that carbon nanothreads have excellent mechanical properties, for example a high stiffness of ˜850 GPa and a bending rigidity of ˜5.35×10⁻²⁸ N·m^{2,12,16,17} The stiffness and bending rigidity of carbon nanothreads are not good for solvation. The carbon nanothread crystals are thus extremely difficult to manipulate and to process into composites or thin films.

In view of the many fascinating novel electronic, thermal and mechanical properties of carbon nanothreads, many applications that will take advantage of these properties will require large-scale manipulations of stable organic and aqueous dispersions of exfoliated carbon nanothreads having high weight fractions of small bundles and individualized carbon nanothreads. Indeed, the most promising applications of carbon nanothreads in nanoelectronics, optoelectronic systems, chemical sensors, polymer nanocomposites, and energy storage require their prior solution-phase disentanglement into small bundles and individualized carbon nanothreads.

At the present time, there is no known method of forming dispersions of exfoliated carbon nanothreads in any solvent. The main hurdle to the widespread use of carbon nanothreads remains the lack of methods to produce pristine, well exfoliated, small bundles and individualized carbon nanothreads in the liquid phase. Accordingly, the development of suitable methods to solubilize or disperse small bundles and individualized carbon nanothreads in organic and aqueous environments is presently needed.

The dispersions of exfoliated carbon nanothreads will enable the use of a variety of solution-phase purification, processing, and deposition techniques. The exfoliation and dispersion of exfoliated carbon nanothreads will give possibilities for their further functionalization into functional materials such as drug carriers, and biomedical imaging probes. The well dispersed exfoliated carbon nanothreads will provide nanoscale building blocks that can be industrially processed and reassembled into functional structures such as thin films, aerogels, and fibers. Dispersions of exfoliated carbon nanothreads may be useful for producing, by impregnation, composites containing carbon nanothreads. They also open the way to purifying and sorting of carbon nanothreads by structure and/or length.

There is also a present need to be able to exfoliate and disperse unshortened small bundles and individualized carbon nanothreads in organic and aqueous environments. This will allow their integrity, and hence their properties, to be preserved.

There is also a present need to be able to controllably deposit carbon nanothread networks on conducting and nonconducting substrates. This will be particularly useful in preparing carbon nanothread-based circuits and sensors.

One of the technical solutions provided by the methods disclosed in the present disclosure is providing a method for exfoliating and dispersing carbon nanothreads without using surfactants or polymeric dispersants and ultrasound, and without acid treatments. Surfactants and polymeric dispersants may have a significant impact on the physical properties of carbon nanothreads because the residual surfactants and polymeric dispersants are difficult to remove from carbon-based nanomaterials.^{18,19} Thus, it has turned out that a technical solution provided by the present disclosure can be achieved by chemically reducing, carbon nanothread samples to form carbon nanothread alkali metal compounds followed by their dissolution/dispersion in aprotic organic solvents.

### SUMMARY OF THE INVENTION

Embodiments relate to methods for preparing organic and aqueous dispersions of exfoliated carbon nanothreads. This can involve methods for preparing organic and aqueous dispersions of exfoliated carbon nanothreads that allows their integrity, and hence their properties, to be preserved.

In some embodiments, methods of exfoliating and dispersing carbon nanothreads can be characterized in that the methods can involve the reduction of carbon nanothreads using an alkali metal to form a carbon nanothread alkali metal compound, and dissolution/dispersion of the resulting carbon nanothread alkali metal compound in a polar aprotic organic solvent. The carbon nanothread alkali metal compound is made up of carbon nanothreads with alkali metal atoms intercalated in between the nanothreads. There is charge transfer between the alkali metal with the sp² sections of carbon nanothreads. The charge transfer makes the carbon nanothreads negatively charged and soluble in aprotic solvents as polyelectrolytes.

In some embodiments, methods involve the use of the carbon nanothread alkali metal compound as a precursor for the preparation of organic and aqueous dispersions of exfoliated small bundles and individualized carbon nanothreads, and the use of the organic and aqueous dispersions to make carbon nanothread deposits on conductive and nonconductive substrates and preparation of polymer nanocomposites.

Some embodiments relate to providing a carbon nanothread alkali metal compound obtained by any of the production methods disclosed herein.

In an exemplary embodiment, a method for reducing carbon nanothreads to form a carbon nanothread alkali metal compound can involve:
(i) Heating, in an inert environment, carbon nanothread crystals and an alkali metal to a temperature>melting point (m.p.) of the alkali metal and mixing in a glass vial to obtain a carbon nanothread alkali metal compound;
(ii) Leaving to stand, in an inert environment, the carbon nanothread alkali metal compound while heating and mixing occasionally for a certain time, to cause the alkali metal reduction/intercalation reaction.

The alkali metal can be one or more of lithium, sodium, potassium, rubidium, and cesium or any of their mixtures. The carbon nanothreads can include all the possible carbon nanothread types. The stoichiometric ratio of the carbon nanothreads material to the alkali metal in step (1) can be a value between 1 and 60. The carbon nanothreads and alkali metal containing vial can be allowed to stand over a hotplate at a temperature above the melting point of the alkali metal in an inert environment, generally 5 hours or more. The inert environment can include argon atmosphere and/or a nitrogen atmosphere and others. The mixing can be done using a glass rod or a stainless-steel spatula.

Beneficial effects of the carbon nanothread alkali metal compound can include:
The preparation of carbon nanothread alkali metal compound can be performed at low temperatures (e.g., less than 150° C.).
It is done at atmospheric pressure and is suitable for the preparation of carbon nanothread alkali metal compounds on a large scale.
The preparation method of the present invention abandons the conventional ultra-low vacuum and the high temperature preparation method used for other carbon nanomaterial reduction processes.
The preparation method is solvent free, fast (e.g., less than 12 hours), low in energy consumption and small in pollution (no waste organic solvents produced), and is suitable for industrial large-scale production.

To the inventors' knowledge there is no known system or method that achieves dispersion of carbon nanothreads. Fabricating a carbon nanothread alkali metal compound is a way to make these dispersible/soluble. Known methods of making alkali metal compounds for other materials that are not nanothreads, use ultrahigh vacuum and high temperature heating for over 72 hours. Yet, the disclosed method is simple and faster.

Some embodiments relate to providing organic and aqueous dispersions of exfoliated small bundles and individualized carbon nanothreads obtained by the production method.

In an exemplary embodiment, a method for preparing organic and aqueous dispersions of exfoliated small bundles and individualized carbon nanothreads by dissolving/dispersing carbon nanothread alkali metal compounds can involve the following steps carried out under inert atmosphere:
(i) Reduction of carbon nanothreads by an alkali metal to lead to a carbon nanothread alkali metal compound;
(ii) Exposing the carbon nanothread alkali metal compound to an aprotic organic solvent (A) or a mixture (A′) of aprotic organic solvents leading to the spontaneous dissolution of carbon nanothreads; and
(iii) Continued stirring of the mixture leading to a solution/dispersion of reduced exfoliated carbon nanothreads in an aprotic organic solvent.

The alkali metal can be any alkali metal allowing the implementation of the disclosed method. It can be chosen, for example, in the group comprising lithium, sodium, potassium, rubidium, cesium, or any of their mixtures. More particularly, the alkali metal can be sodium, potassium or cesium. Preferably, the alkali metal is potassium. The aprotic organic solvent used in the mixing step (2) and (3) can have a dielectric constant between 25 and 200. The mixing can be conducted in a glass container at a temperature between −22 to 202° C. (most, if not all of the disclosed solvents are in a liquid phase within this range). The mixing can be achieved by mechanical stirring for a time longer than 1 second. The solutions/dispersions of reduced exfoliated carbon nanothreads can contain a high weight fraction of individualized carbon nanothreads and small bundles of carbon nanothreads. The solutions/dispersions of reduced exfoliated carbon nanothreads in an aprotic organic solvent will be stable indefinitely as long as kept under inert environment.

Some embodiments relate to providing air stable dispersions of exfoliated carbon nanothreads obtained by any of the production methods disclosed herein.

In an exemplary embodiment, a method for preparing organic or aqueous dispersions of exfoliated carbon nanothreads can involve the following additional steps:
(iv) Neutralizing the solutions/dispersions of reduced exfoliated charged carbon nanothreads by exposing to air containing oxygen; and
(v) Mixing the organic dispersions of exfoliated carbon nanothreads obtained in step (iv) with a suitable amount of water, ionic aqueous solution, organic solvent (B), or mixture (B′) of organic solvents, or mixture of (B) or (B′) with water or an aqueous ionic solution.

Solvent (A) or solvent mixture (A′) can be fully or partially water miscible or full or partially miscible with solvent (B) or solvent mixture (B′). This can lead to stable aqueous or organic dispersions of exfoliated carbon nanothreads.

The obtained dispersions of exfoliated carbon nanothreads obtained by the method can have the following features: the exfoliated carbon nanothreads have a thickness of 1-5 carbon nanothreads and a lateral dimension of greater than a few nanometers in length.

Beneficial effects of the air stable organic and aqueous dispersions of exfoliated carbon nanothreads obtained can include:
A carbon nanothread alkali metal compound is used as the precursor, and the preparation of dispersions of exfoliated carbon nanothreads is done at room temperature and mild stirring. It is suitable for preparation of dispersions exfoliated small bundles and individualized carbon nanothreads on a large scale in a wide variety of solvents.
The preparation method abandons the conventional high-energy preparation method such as ultrasonication or mechanical shearing.
The dispersions of exfoliated carbon nanothreads obtained contain predominantly individualized carbon nanothreads and small bundles of carbon nanothreads. The suspensions are surfactant-free and in low boiling point solvents.
Depending on the envisaged applications, the carbon nanothreads can be benzene derived carbon nanothreads of the form CH or may contain heteroatoms such as O, N, S or B as a substitute for carbon atoms.
The carbon nanothreads to be exfoliated and dispersed may also include such carbon nanothreads containing organic functional groups attached to the carbon backbone.

In some embodiments, the method of dissolving carbon nanothreads may further include a step of purifying the carbon nanothreads. The method may also include a step of attaching functional groups to the carbon backbone of the carbon nanothreads using different organic functionalization reactions.

The dispersions obtained can be used for impregnating polymers, for mechanical reinforcement, or else they can be deposited on substrates in order to form thin, optionally oriented films, with sensing, optoelectronic, photochemical and electrochemical properties/applications.

Starting from these dispersions, it is possible to purify the carbon nanothreads (for example by selective dissolution/dispersion, filtration, chromatography, electrophoresis), to obtain pure carbon nanothreads, carbon nanothread films and, in general to carry out forming operations resulting in any type of device that exploits the greatly beneficial chemical, mechanical, electrical, and optical properties of carbon nanothreads. In particular, these dispersions can lead to multifunctional polymer nanocomposites, either by mixing with a polymer soluble in organic solvents or water, or by mixing with a monomer followed by subsequent polymerization.

An exemplary embodiment can relate to a method for preparing a dispersion of carbon nanothreads in polar aprotic organic solvents. The method can involve (a) providing a carbon nanothread alkali metal compound, made up of carbon nanothreads with alkali metals intercalated in between the carbon nanothreads. The method can involve (b) adding an organic polar aprotic solvent (A) or a mixture (A′) of polar aprotic solvents under anhydrous inert atmosphere to the carbon nanothread alkali metal compound of step (a).

In some embodiments, step (b) can be performed in the absence of sonication.

In some embodiments, step (b) can generate a dispersion comprising a dispersed/dissolved phase of exfoliated reduced carbon nanothreads with positive counterions.

In some embodiments, the method can involve generating a meta-stable organic dispersion of carbon nanothreads by exposing the dispersion of step (b) to air or oxygen to neutralize the reduced carbon nanothreads.

In some embodiments, the carbon nanothreads can include nanothreads containing no heteroatoms or nanothreads containing N, B, S, Se, O, S, Si, or P heteroatoms in the carbon nanothread backbone.

In some embodiments, the polar organic solvent can be tetrahydrofuran, sulfolane, dimethyl sulfoxide, dimethylformamide, N-methylpyrrolidone, N-methylformamide, acetone, acetonitrile, dichloromethane, dimethylformamide, dimethylpropyleneurea, ethyl acetate, or hexamethylphosphoric triamide.

In some embodiments, the method can involve preparing the carbon nanothread alkali metal compound provided in step (a) by: (i) reduction of carbon nanothreads by an alkali metal in vapor or molten phase; and (ii) reduction of carbon nanothreads by an alkali metal salt of formula M+B−, wherein M+ represents an alkali metal cation, and wherein the alkali metal is selected from lithium, sodium, potassium, rubidium or cesium; and B− represents polyaromatic hydrocarbon; or (iii) electrochemical reduction of carbon nanothreads.

An exemplary embodiment can relate to a method of preparing a carbon nanothread alkali metal compound. The method can involve (i) reduction of carbon nanothreads by an alkali metal in vapor or molten phase; (ii) reduction of carbon nanothreads by an alkali metal salt of formula M+B−, wherein M+ represents an alkali metal cation, and wherein the alkali metal is selected from lithium, sodium, potassium, rubidium or cesium; and B− represents polyaromatic hydrocarbon; or (iii) electrochemical reduction of carbon nanothreads.

An exemplary embodiment can relate to a method of preparing a solution/dispersion of exfoliated reduced carbon nanothreads in a polar aprotic organic solvent. The method can involve adding an organic polar aprotic solvent (A) or a mixture (A′) of polar aprotic solvents under anhydrous inert atmosphere to a carbon nanothread alkali metal compound.

An exemplary embodiment can relate to method of preparing a dispersion of exfoliated carbon nanothreads in polar aprotic organic solvent. The method can involve exposing dispersions carbon nanothreads to air or oxygen to neutralize reduced carbon nanothreads to generate meta-stable organic dispersions of carbon nanothreads.

In some embodiments, the method involves: (d) mixing the meta-stable organic dispersion of neutralized exfoliated carbon nanothreads with a predetermined amount of water, or ionic aqueous solution; and (e) evaporating the organic polar aprotic solvent (A) or the mixture (A′) of polar aprotic solvents to generate an air stable dispersion of carbon nanothreads in water.

In some embodiments, the organic polar aprotic solvent (A) or the mixture (A′) of organic polar aprotic solvents can be fully or partially water miscible.

In some embodiments, the method involves preparing a homogeneous dispersion of carbon nanothreads in water.

In some embodiments, the method involves preparing a dispersion of individualized and small bundles of carbon nanothreads.

An exemplary embodiment can relate to a method for preparing a composite material. The method can involve: preparing a dispersions of carbon nanothreads in in polar aprotic organic solvents in accordance with an embodiment disclosed herein; and generating a composite material from the dispersion of carbon nanothreads.

An exemplary embodiment can relate to a method for preparing a composite material. The method can involve: preparing a dispersion of carbon nanothreads in in polar aprotic organic solvents in accordance with an embodiment disclosed herein; and generating a composite material from the dispersion of carbon nanothreads. The composite material can be obtained by: mixing the dispersion of carbon nanothreads with a polymer solution or a polymer mixture solution; or in situ polymerization of a monomer or mixture or monomers in the dispersion of carbon nanothreads.

In some embodiments, the method involves: (i) freezing organic or aqueous dispersions of the dispersion of carbon nanothreads to generate a solvent of organic or aqueous dispersions; and (ii) subliming the solvent of organic or aqueous dispersions to form an aerogel of carbon nanothreads.

In some embodiments, the carbon nanothreads contain N, B, S, Se, O, S, Si, or P heteroatoms in the carbon nanothread backbone.

In some embodiments, the carbon nanothreads contain organic and organometallic functional groups attached to the carbon nanothread backbone.

In some embodiments, the method involves a step of functionalizing the carbon nanothread backbone or the ends of the carbon nanothreads.

In some embodiments, the polyaromatic hydrocarbon can be naphthalene, benzophenone, fluorenone, or anthraquinone.

An exemplary embodiment can relate to a method for producing a thin film on a substrate for an electronic device. The method can involve preparing a dispersion of carbon nanothreads in polar aprotic organic solvents in accordance with an embodiment disclosed herein; depositing the dispersion carbon nanothreads on a substrate.

In some embodiments, depositing the dispersion of carbon nanothreads can involve spin coating, drop-casting, vacuum filtration, plating, spray coating, chemical vapor deposition, or physical vapor deposition.

In some embodiments, the electronic device can be a chemical sensor, a molecular sensor, or a photodetector.

An exemplary embodiment can relate to a composition including a dispersion having a dispersed/dissolved phase of exfoliated reduced carbon nanothreads with positive counterions.

In some embodiments, the dispersion can include individualized and small bundles of carbon nanothreads.

In some embodiments, the carbon nanothreads can contain N, B, S, Se, O, S, Si, or P heteroatoms in the carbon nanothread backbone.

In some embodiments, the carbon nanothreads can contain organic and organometallic functional groups attached to the carbon nanothread backbone.

An exemplary embodiment can relate to a composite material including an embodiment of a dispersion disclosed herein.

An exemplary embodiment can relate to an aerogel including an embodiment of a dispersion disclosed herein.

An exemplary embodiment can relate to a thin film or substrate including an embodiment of a dispersion disclosed herein.

Further features, aspects, objects, advantages, and possible applications of the present invention will become apparent from a study of the exemplary embodiments and examples described below, in combination with the Figures, and the appended claims.

### BRIEF DESCRIPTION OF THE DRAWINGS

The above and other objects, aspects, features, advantages and possible applications of the present invention will be more apparent from the following more particular description thereof, presented in conjunction with the following drawings, in which:

FIG. 1 shows an exemplary method for preparing homogeneous dispersions of individualized and small bundles of carbon nanothreads in polar aprotic organic solvents.

FIG. 2 shows characterization of as synthesized pyridine carbon nanothreads, wherein (a) is XRD image of pyridine carbon nanothread sample, (b) is IR spectrum of pyridine carbon nanothread sample, and (c) is a TGA result of pyridine carbon nanothread sample under Ar atmosphere.

FIG. 3 shows: (a) a schematic illustration and pictures of the reduction of pyridine carbon nanothreads using potassium metal to form a pyridine carbon nitride potassium compound; and (b) a schematic illustration and pictures of the dissolution/dispersion of pyridine carbon nanothread potassium compound in organic aprotic solvent to form a solution/dispersion of exfoliated pyridine carbon nanothreads.

FIG. 4 shows characterization of the dispersions of exfoliated pyridine carbon nanothreads, wherein (a) shows the pyridine carbon nanothread dispersion UV-vis absorption spectrum demonstrates absorption peaks in the 300-450 nm range, (b) shows the photoluminescence excitation-emission map demonstrating a broad PL in the region between 350 and 650 nm and another peak above 800 nm, and (c) shows the dispersions of exfoliated pyridine carbon nanothread in different solvents demonstrating a blue photoluminescence under UV illumination, while no PL is observed in pure water as represented by the picture in (c) of FIG. 3.

FIG. 5 shows deposition and characterization of pyridine carbon nanothread films on conducting and nonconducting substrates, wherein (a) shows a photograph of the vacuum filtered pyridine carbon nanothreads on a commercial nitrocellulose membrane; the edge of the pyridine carbon nanothread film is marked with a black dotted line, (b) shows a photograph of small pieces of the nitrocellulose membrane holding the pyridine carbon nanothread film stamped on silicon substrates, (c) shows pyridine carbon nanothread thin film on silicon substrate after dissolving and washing off the nitrocellulose membrane, (d) shows an AFM topography image of a thin pyridine carbon nanothread film deposited on a Si substrate demonstrating a percolating network of a few hundred nanometer-long carbon nanothreads, and (e) shows height distribution measurements from the pyridine carbon nanothread film showing that most of the carbon nanothreads are individualized and some are small bundles (2-5 nanothreads).

FIG. 6 shows XPS of pyridine carbon nanothread film on Si substrate, wherein (a) shows high resolution C1s XPS, and (b) shows high resolution N1s XPS scan, which are presented as experimental data (black squares) and fitted curves (solid lines). The XPS data of the pyridine carbon nanothread film is similar to the XPS data of pristine as synthesized pyridine carbon nanothreads.

FIG. 7 shows pyridine carbon nitride-based chemical sensors, wherein (a) shows a schematic representation of the interdigitated electrodes (IDEs) used for fabrication pyridine carbon nanothread-based chemical sensors, (b) shows a picture of the pyridine carbon nanothread-based chemical sensor placed on a microprocessor holder, (c) shows a picture of sensing platform demonstrating how acetone and ethanol were inundated with argon in a glass bubbler and carried through to an outlet nozzle positioned on top of the sensing devices, (d) shows a representative sensor response from the pyridine carbon nanothread-based chemical sensor for ethanol vapor, and (e) shows a representative sensor response from the pyridine carbon nanothread-based chemical sensor for acetone vapor. Argon is used for carrying the organic vapors and purging.

FIG. 8 shows a pyridine carbon nanothread-based photodetector, wherein (a) is a schematic representation of the pyridine carbon nanothread-based photodetector device, and (b) shows the photoresponse of a pyridine carbon nanothread photodetector under an illumination from a 405 nm laser.

### DETAILED DESCRIPTION OF THE INVENTION

The following description is of an embodiment presently contemplated for carrying out the present invention. This description is not to be taken in a limiting sense, but is made merely for the purpose of describing the general principles and features of the present invention. The scope of the present invention should be determined with reference to the claims.

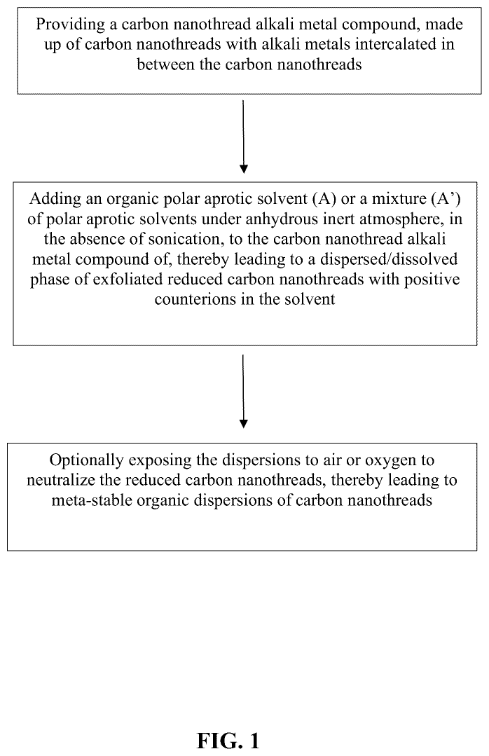

Referring to FIG. 1, embodiments relate to methods for efficiently dispersing carbon nanothreads through alkali metal reduction of carbon nanothread crystals and dissolution in polar aprotic solvents. Carbon nanothreads are a type of ultrathin one-dimensional carbon nanomaterial consisting of a strong sp³-bonded carbon core surrounded by hydrogen atoms. Organic and aqueous dispersions of exfoliated bundles and individualized carbon nanothreads and a method for making the dispersions is provided. In some embodiments, the method of exfoliating and dispersing carbon nanothreads is characterized in that it comprises the reduction of carbon nanothreads using an alkali metal to form a carbon nanothread alkali metal compound, and dissolution/dispersion of the resulting carbon nanothread alkali metal compound in a polar aprotic organic solvent. The carbon nanothread alkali metal compound can be made up of carbon nanothreads with alkali metal atoms intercalated in between the nanothreads. There is charge transfer between the alkali metal with the sp² sections of carbon nanothreads. The charge transfer makes the carbon nanothreads negatively charged and soluble in aprotic solvents as polyelectrolytes. In some embodiment, methods disclosed herein can relate to the use of the carbon nanothread alkali metal compound as a precursor for the preparation of organic and aqueous dispersions of exfoliated small bundles and individualized carbon nanothreads, and the use of the organic and aqueous dispersions to make carbon nanothread deposits on conductive and nonconductive substrates and preparation of polymer nanocomposites.

Embodiments relate to methods for preparing a dispersion (or dispersions) of carbon nanothreads. This can include a dispersion of carbon nanothreads in polar aprotic organic solvents. For instance, the inventive methods can prepare distributed particles of carbon nanothreads in a continuous phase of a polar aprotic organic solvent(s). The resultant dispersion can be a homogeneous dispersion of carbon nanothreads. The resultant dispersion can be a dispersion of individualized and small bundles of carbon nanothreads. An exemplary method can involve: (a) providing a carbon nanothread alkali metal compound, made up of carbon nanothreads with alkali metals intercalated in between the carbon nanothreads; and (b) adding an organic polar aprotic solvent (A) or a mixture (A′) of polar aprotic solvents under anhydrous inert atmosphere to the carbon nanothread alkali metal compound of step (a). The polar organic solvent(s) can be tetrahydrofuran, sulfolane, dimethyl sulfoxide, dimethylformamide, N-methylpyrrolidone, N-methylformamide, acetone, acetonitrile, dichloromethane, dimethylformamide, dimethylpropyleneurea, ethyl acetate, hexamethylphosphoric triamide, etc.

Some embodiments can involve freezing organic or aqueous dispersions of the dispersion of carbon nanothreads to generate a solvent of organic or aqueous dispersions followed by subliming the solvent of organic or aqueous dispersions to form an aerogel of carbon nanothreads. Nanothread cryogels were obtained by freezing a dispersion of carbon nanothreads in DMSO in liquid nitrogen, then the frozen DMSO was sublimed by exposing it to vacuum for 48 hours.

It is contemplated for step (b) to be performed in the absence of sonication. Exfoliation and dispersion of nanothreads using sonication will lead to their shortening, which is detrimental to percolation properties (electrical, thermal, mechanical, etc.). The process of step (b) generates a dispersion comprising a dispersed/dissolved phase of exfoliated reduced carbon nanothreads with positive counterions.

In some embodiments, the method can involve generating a meta-stable organic dispersion of carbon nanothreads by exposing the dispersion of step (b) to air or oxygen to neutralize the reduced carbon nanothreads. The neutralization is achieved by leaving the dispersed/dissolved phase of exfoliated reduced carbon nanothreads in a polar aprotic organic solvent to air for 2 minutes with gentle stirring using a glass rod. Some embodiments can involve mixing the meta-stable organic dispersion of neutralized exfoliated carbon nanothreads with a predetermined amount of water, or ionic aqueous solution followed by evaporating the organic polar aprotic solvent (A) or the mixture (A′) of polar aprotic solvents to generate an air stable dispersion of carbon nanothreads in water. The organic polar aprotic solvent (A) or the mixture (A′) of organic polar aprotic solvents can be fully or partially water miscible.

It is understood that the carbon nanothreads can include any type of nanothreads. The type of the nanothread is defined by the bonding pattern of atoms in the nanothread structure. The carbon nanothreads can contain any heteroatom such as N, B, S, Se, O, S, Si, or P in the carbon nanothread backbone. For example, some of the heteroatoms can change the band gap of the nanothreads, improve the mechanical properties, improve optical properties, or improve processability. The carbon nanothreads can contain any organic functional groups attached to the carbon nanothread backbone.

It is contemplated for the carbon nanothread alkali metal compound provided in step (a) to be prepared by reduction of carbon nanothreads by an alkali metal in vapor or molten phase. In addition, or in the alternative, the carbon nanothread alkali metal compound can be prepared by reduction of carbon nanothreads by an alkali metal salt of formula M⁺B⁻. M⁺ represents an alkali metal cation. The alkali metal can be lithium, sodium, potassium, rubidium, cesium, etc. B⁻ represents polyaromatic hydrocarbon. The polyaromatic hydrocarbon can be naphthalene, benzophenone, fluorenone, anthraquinone, etc. In addition, or in the alternative, the carbon nanothread alkali metal compound can be prepared by electrochemical reduction of carbon nanothreads.

The method can involve functionalizing the carbon nanothread backbone or the ends of the carbon nanothreads, for example using the reductive functionalization chemistry. Once nanothreads are dispersed in a solvent, it will become possible to add organic, polymeric, and organometallic functional groups that are not possible to include in the nanothread precursor.

As can be appreciated, this disclosure provides an inventive method of preparing a solution/dispersion of exfoliated reduced carbon nanothreads in a polar aprotic organic solvent. This method can involve adding an organic polar aprotic solvent (A) or a mixture (A′) of polar aprotic solvents under anhydrous inert atmosphere to a carbon nanothread alkali metal compound.

As can be further appreciated, this disclosure provides an inventive method of preparing a dispersion of exfoliated carbon nanothreads in polar aprotic organic solvent. This method can involve exposing solutions/dispersions of carbon nanothreads to air or oxygen to neutralize reduced carbon nanothreads to generate meta-stable organic dispersions of carbon nanothreads.

The inventive methods can be used to prepare composite materials (e.g., polymer nanocomposites). For instance, a dispersion of carbon nanothreads in polar aprotic organic solvents can be prepared in accordance with any of the methods disclosed herein. A composite material can then be prepared from the dispersion of carbon nanothreads. The composite material can be obtained by mixing the dispersion of carbon nanothreads with a polymer solution or polymer mixture solutions. For example, polyhydroxyaminoether (PHAE) in chloroform, polyvinyl acetate in water, low-density polyethylene in diclorobenzene, high-density polyethylene in dichlorobenzene, or their mixtures. In addition, or in the alternative, the composite material can be obtained by in situ polymerization of monomers such as pyrrole or phenylacetylene in the dispersion of carbon nanothreads.

The inventive methods can be used for producing a thin film on a substrate for an electronic device. For instance, a dispersion of carbon nanothreads in polar aprotic organic solvents can be prepared in accordance with any of the methods disclosed herein. The dispersion can then be deposited on a substrate. The deposition of the dispersion of carbon nanothreads can involve spin coating, drop-casting, vacuum filtration, plating, spray coating, chemical vapor deposition, or physical vapor deposition. The prepared substrate and/or thin film can be used as a component (e.g., a switch, a diode, a transistor, a conductive channel, etc.) in the electronic device. The electronic device can be a chemical sensor, a molecular sensor, a photodetector, etc. Other electronic devices can include electrocatalytic electrodes, optoelectronic devices, etc.

### EXAMPLES

For further understanding of the embodiments disclosed, the following examples are provided to illustrate the preparation methods and applications of dispersions of exfoliated carbon nanothreads. The methods will now be exemplified using certain carbon nanothreads and solution/dispersions of exfoliated carbon nanothreads. Embodiments of the methods disclosed herein and their applications can be understood further by the examples that illustrate some of the embodiments by which the inventive methods may be reduced to practice. It will be appreciated, however, that these examples do not limit the invention.

### Example 1a: Synthesis of Pyridine Carbon Nanothreads

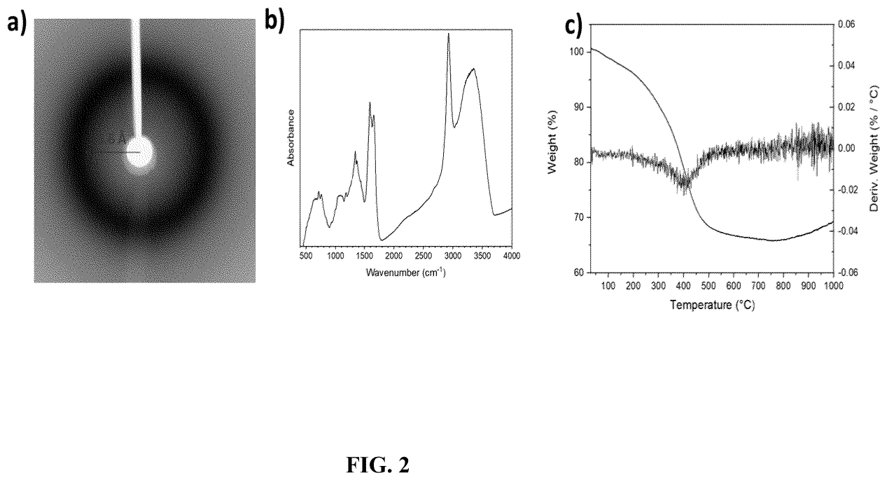

Pyridine carbon nanothreads were synthesized by compressing 20 mg of pyridine in a Paris-Edinburgh press up to 23 GPa at a compression/decompression rate of 1-2 GPa/h.⁹ Each synthesis yielded about 3 mg of pyridine carbon nanothread product, equivalent to 15% yield. The recovered nanothread product was characterized by X-ray diffraction (XRD) and FT-IR. FIG. 2(a) shows a diffraction ring at the d-spacing of 5.6 Å, which is indicative of the crystalline 2D packing of pyridine carbon nanothreads. The sp³ C—H stretching vibration (2850-2960 cm⁻¹) and C═C or C═N stretching vibration (1680-1585 cm⁻¹) in the IR spectrum (FIG. 2(b)) suggest that pyridine nanothreads consist of sp³-hybridized carbon with a fraction of unsaturated sp² carbon bonds. Thermal gravimetric analysis (TGA) (FIG. 2(c)) shows that pyridine carbon nanothreads have an initial decomposition temperature of above 350° C. under Ar atmosphere.

### Example 1b: Synthesis of a Pyridine Carbon Nanothread Potassium Compound

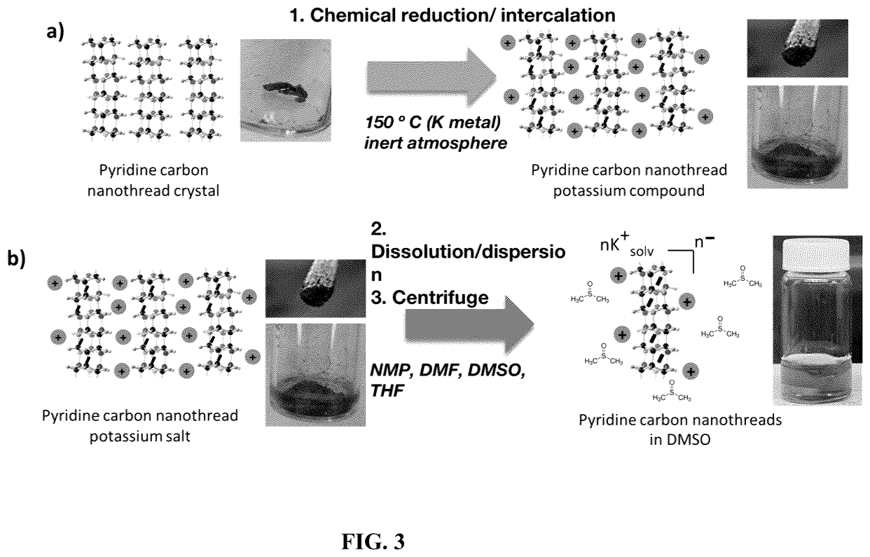

The synthesis of pyridine carbon nanothread potassium compound was carried out in an argon filled glove box. A pyridine carbon nanothread (carbon nitride nanothread) sample of stoichiometry (C₅NH₅) was utilized in this experiment. To form the pyridine carbon nanothread potassium compound with stoichiometry K(C₅NH₅)₂, 9 g of pyridine carbon nanothread crystals and 4 mg of freshly cleaved potassium metal were placed together in a glass vial and heated for 5 hours at 100° C. on a heating plate under occasional stirring with a stainless-steel spatula. This reaction temperature is way below the decomposition of pyridine carbon nanothreads (see FIG. 2(c)). A gas phase intercalation reaction will not achieve the intercalation reaction here because it requires a heating temperature above 250° C. which is closer to the thermal decomposition of the carbon nanothreads. The reaction between the dark orange pyridine carbon nanothread crystals and the shiny silver potassium metal yielded a dark brown pyridine carbon nanothread potassium compound product with a stoichiometry of K(C₅NH₅)₂ as illustrated in FIG. 3(a). Afterwards, the vial is allowed to cool down to room temperature and the pyridine carbon nanothread potassium compound is collected. The resulting pyridine carbon nanothread potassium compound is directly used or stored in a tightly sealed glass vial for further processing. By way of illustration, an example of a synthesis carried out on a laboratory scale is reported: all the handling operations were carried out in a glove box in a dry argon atmosphere (O₂ content<0.1 ppm; H₂O content<0.1 ppm).

Varying the quantity of potassium mixed and heated together with the pyridine carbon nanothreads allows accurate control of the reduction level. In this synthesis, a stoichiometry of K(C₅NH₅)₂ was chosen in order to have a sufficiently high concentration on nanothreads dissolved in the aprotic organic solvents but low reactivity upon later exposure to air and water. The exfoliation and dissolution/dispersion depends on the amount of charge on the nanothread. In this pyridine carbon nanothread potassium compound, the pyridine carbon nanothreads are reduced by the potassium intercalated in between the nanothreads. The pyridine carbon nanothread potassium compound is a form of an intercalation compound. The dark brown pyridine carbon nanothread potassium compound remained stable for over a year when stored under inert argon glove box environment. When the dark brown pyridine carbon nanothread potassium compound was exposed to air, a popping sound was heard, and a spark of fire was observed due to deintercalation and burning of the pyridine carbon nanothreads. The dark brown pyridine carbon nanothread potassium compound is highly reducing and can burn in the presence of oxygen due to oxidation.

### Example 2a: Dissolution of the Pyridine Carbon Nanothread Potassium Compound in Organic Aprotic Solvents

Pyridine carbon nanothreads were successfully exfoliated and dispersed by reductive dissolution in the polar aprotic organic solvents THF, DMF, NMP and DMSO. The polar organic solvents THF, DMF, NMP and DMSO were added to the pyridine carbon nanothread potassium compound and the mixtures were agitated for 48 hours using a magnetic stirrer to form a brown solution/dispersion as presented in the scheme in FIG. 3(b). After a few minutes to a few hours, a brown solution/dispersion was obtained, the darkness depending on the solubility and concentration of the pyridine carbon nanothreads in the organic aprotic solvent used.

Exposure of the pyridine carbon nanothread potassium compound to polar aprotic solvents such as DMSO, NMP, DMF and THF readily and spontaneously exfoliates the pyridine carbon nanothreads and yield solutions/dispersions of reduced exfoliated carbon nanothreads, affording a virtually unlimited amount of individualized and small bundles of carbon nanothreads. A control experiment with neutral pyridine carbon nanothreads crystals gave a colorless transparent liquid after the same procedure, nothing was dissolved/dispersed even after sonication. Upon reduction with alkali metals, carbon nanothreads form polyelectrolytes that are soluble in polar organic solvents forming true thermodynamically stable solutions/dispersions. Pyridine carbon nanothread salts can bear a sufficient electrostatic charge to form a new, stiff, conducting polyelectrolyte that is spontaneously soluble in certain solvents.

A mild centrifugation (1000 rpm, 5 minutes) allows the solution/dispersion of exfoliated reduced carbon nanothreads to be separated from the remaining, insoluble, material. The resulting solution/dispersions of pyridine carbon nanothreads contains well exfoliated reduced small bundles of pyridine carbon nanothreads and reduced individualized pyridine carbon nanothreads (vide infra). The dispersions of pyridine carbon nanothreads were metastable and remained stable in all of THF, DMF, NMP and DMSO as long as they were stored under an oxygen free dry atmosphere.

For the pyridine carbon nanothreads to be able to be easily handled in the open air for applications not requiring the nanothreads to be reduced, their neutral state was restored by exposing the dispersion to air. In the case of THF, the pyridine carbon nanothreads reaggregated after air exposure. In all the other cases, the carbon nanothreads remained dispersed for several weeks in DMSO, DMF, and NMP and were kept for processing into polymer nanocomposites and films for characterization and electronic device fabrication. The dispersions of pyridine carbon nanothreads were characterized using absorption spectroscopy, photoluminescence spectroscopy. The resulting dispersions of pyridine carbon nanothreads contains well exfoliated small bundles of pyridine carbon nanothreads and completely individualized pyridine carbon nanothreads (vide infra) in organic solvents.

### Example 2b: Transfer of Exfoliated Pyridine Carbon Nanothreads from Polar Aprotic Solvents to Water

Aqueous dispersions of pyridine carbon nanothreads were prepared by mixing the pyridine carbon nanothread dispersions in THF made in (1b) with deionized water in different mass proportions. A 20 mL glass vial was filled with 4 mL deionized water; this was followed by a drop-wise addition of the dispersions of pyridine carbon nanothreads in THF (after its air oxidation for one minute) using a glass Pasteur pipette with gentle stirring. Then, the vial was left open in a dust free environment to allow the THF to evaporate at room temperature with occasional stirring using a glass Pasteur pipette, to form a meta-stable dispersion of exfoliated pyridine carbon nanothreads in water. The exfoliated pyridine carbon nanothreads in water were stable over several weeks. The aqueous colloids of pyridine nanothreads in water have a wide range of potential applications: for example, in environmentally friendly and biocompatible applications. The dispersions were characterized using absorption spectroscopy, and photoluminescence spectroscopy. The resulting dispersions of pyridine carbon nanothreads contains well exfoliated small bundles of pyridine carbon nanothreads and completely individualized pyridine carbon nanothreads (vide infra) in water.

### Absorption and Photoluminescence Spectroscopy.

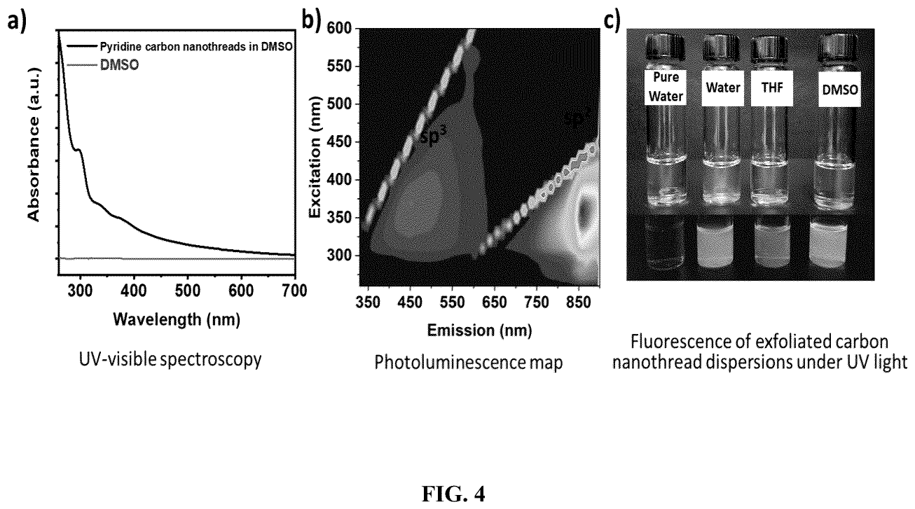

The electronic structure of carbon nanothreads can be monitored by absorption and photoluminescence spectroscopy. The UV-vis absorption spectrum of the dispersion of pyridine carbon nanothreads presented in FIG. 4(a) shows absorption peaks in the 300-450 nm range. The photoluminescence excitation-emission map in FIG. 4(b) shows a broad PL in the region between 350 and 650 nm and another peak above 800 nm. Both PL peaks are in resonance with excitation in the range from 300 to 450 nm. All diluted dispersions containing pyridine carbon nanothreads were transparent and showed strong blue fluorescence under the irradiation of UV lamp at 365 nm while, no PL is observed in the respective pure solvents as represented by the picture in FIG. 4(c). The blue photoluminescence from the pyridine carbon nanothreads, is likely due to bandgap emission.

### Example 3: Pyridine Carbon Nanothread Deposit on Conducting and Nonconducting Substrates

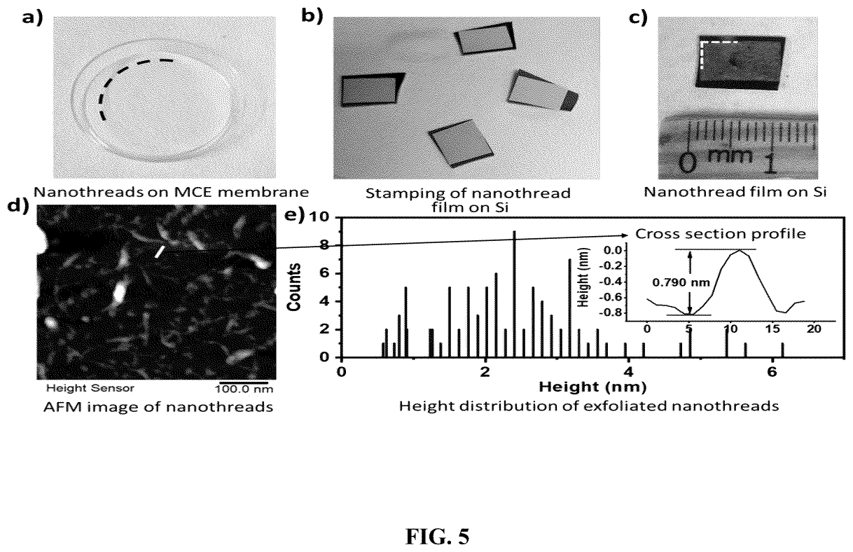

The dispersions of individualized carbon nanothreads have potential for applications in composites and in electronics. After their successful individualization and dispersion in different solvents, they can be deposited on different substrates to form large area transparent thin films of a percolating network of carbon nanothreads. The vacuum filtration and stamping technique is used to produce the large area films of carbon nanothreads. These films can be deposited on different substrates such as Si and Si/SiO₂ and quartz. These films facilitate fabrication optoelectronic devices and sensing devices. Pyridine carbon nanothread films on different substrates were made by vacuum filtration followed by stamping. A 5 mL volume a dispersion of pyridine carbon nanothreads in DMSO were diluted into 200 mL of deionized water and filtered through a 100 nm pore size nitrocellulose membrane filter. A nitrocellulose membrane after filtration of the dispersion of pyridine carbon nanothreads is shown in FIG. 5(a). A yellow film of pyridine carbon nanothreads can be seen coating the surface of the membrane. The nitrocellulose membrane containing the pyridine carbon nanothread film was then cut into small pieces of the required sizes. The pyridine carbon nanothread films were deposited on carefully cleaned substrates by stamping the cut pieces as indicated in the picture in FIG. 5(b). The nitrocellulose membrane was dissolved by placing the films successively in several acetone, methanol, and water baths for 15 min in each bath, to leave a percolating thin film of pyridine carbon nanothreads on the substrate as represented in FIG. 5(c). Quartz, Si/SiO₂, Si and interdigitated gold electrodes on Si/SiO₂ were used as substrates. The density of the pyridine carbon nanothreads deposited on each substrate can be controlled by filtering different volumes of the pyridine carbon nanothread dispersion filtered through the nitrocellulose membrane.

AFM image of a film deposited on Si substrate is presented in FIG. 5(d). Several features are to be noted in this image. The pyridine carbon nanothread film forms a grid-like percolating network; each long thin object corresponds to a single pyridine carbon nanothread or a small bundle on the Si substrate surface. The thickness and coverage of the films can be varied by filtering varying volumes of pyridine carbon nanothread dispersion through the nitrocellulose membrane, followed by deposition onto a substrate by the stamping method. The small bundles and individual pyridine carbon nanothreads have lengths in the 50 nm to a few hundred nanometers. Height measurements yield a height of about 0.59 nm on the thinnest nanothreads measured consistent with the presence of individualized carbon nanothreads (FIG. 4(d)). Statistical distribution on the pyridine carbon nanothread film AFM image shows that most of the carbon nanothreads are individualized, and some are small bundles (2-3 threads) (FIG. 4(e).

X-ray photoelectron spectroscopy (XPS) was used to study the elemental state of the pyridine carbon nanothreads after dispersion and deposition. The spectra were recorded using Physical Electronics VersaProbe II equipped with a monochromatic Al Kα x-ray source (hv=1,486.7 eV) and a concentric hemispherical analyzer. The spot size was 400 μm and the operating pressure was 5×10⁻⁹ Pa. XPS data revealed the presence of C and N peaks in the 284 eV and 400 eV regions respectively, and a small amount of O (not shown).

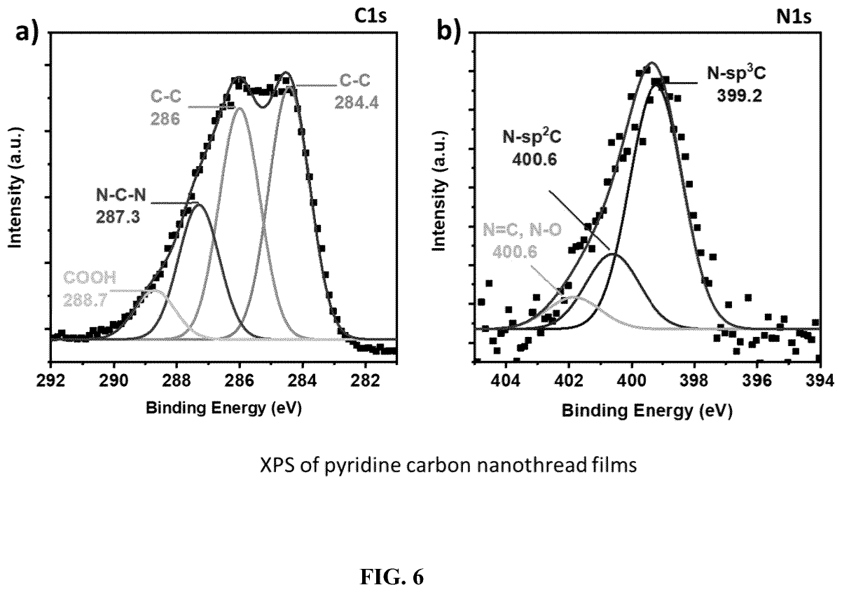

FIG. 6(a) shows the high-resolution C1s spectrum of the pyridine carbon nanothread films on Si substrate. The CIs XPS spectra shows four peaks located at 284.4 eV, 286.0 eV, 287.3 eV, and 288.7 eV. The peak located at 284.4 eV correspond to either sp² or sp³ C—C bonds, while the peak located at 286.0 eV correspond to either sp² or sp³-carbon bonded to one nitrogen. The component at 287.3 eV corresponds to sp³-carbon bonded to two nitrogen neighbors. The component at 288.7 eV corresponds to carboxylic acid groups in the spectrum.

FIG. 6(b) shows the high-resolution N1s spectrum of the pyridine carbon nanothread films on Si substrate. Three peaks at binding energies of 399.2 eV, 400.6 eV, and 402.0 eV were observed on the high resolution N1s spectra of the pyridine carbon nanothread films. The component at 399.2 eV corresponds to nitrogen atoms connected to three sp³-carbon atoms. The component at 400.6 eV corresponds to sp²-nitrogen having at least one sp²-carbon as a nearest neighbor. The component at >402.0 eV corresponds to a combination of N—O bonds and —N═C< bond.

The C1s and N1s region XPS analysis for the pyridine carbon nanothread films was compared with that for the as synthesized pyridine carbon nanothreads. Both spectra show quite similar peak shape. The same C1s and N1s components are present at the same positions and in similar intensities in the spectra of both materials showing that the exfoliation and dispersion technique does not cause any unwanted chemical functionalization to the pyridine carbon nanothread structure.

### Example 4: Determination of Chemical Sensing Activity/Properties of Pyridine Carbon Nanothreads

In this example, a simple pyridine carbon nanothread film-based chemical sensor with extended applications to the sensitive detection of gasses and chemical vapors is demonstrated. Chemical sensors are devices that respond to changes in their chemical environment. A chemical sensor's response must be predictable such that it scales with the magnitude of change in the local chemical environment. Other requirements are the selectivity for detecting a specific chemical in different environments, sensitivity and reversibility operating at different temperatures. In addition, it is also important to note that these sensors should be compact and of low costs.

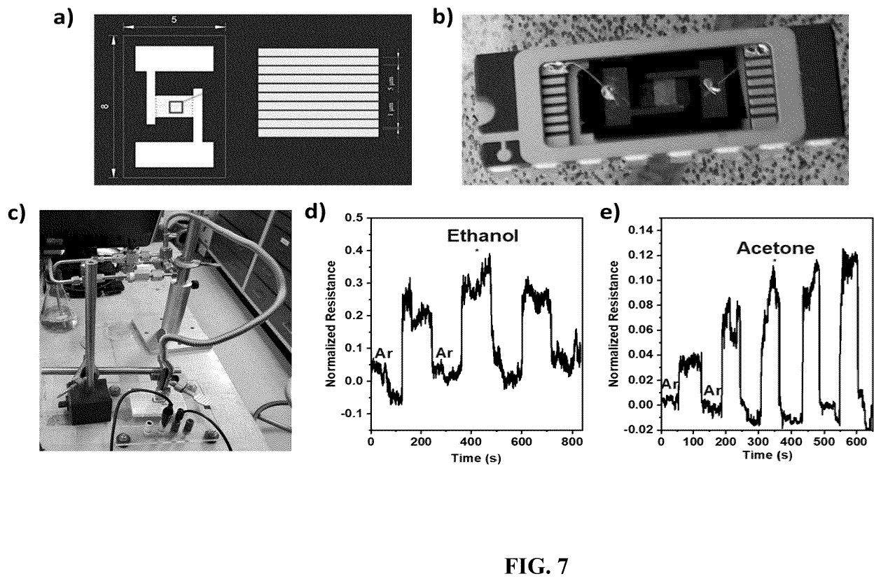

Pyridine carbon nanothreads have a high N content of >16%. The tuneable and high heteroatom concentrations in carbon nanothreads such as pyridine carbon nanothreads may yield sensitive devices. Pyridine carbon nanothreads were investigated as sensing materials in this example. In this platform, pyridine carbon nanothreads form a network on interdigitated electrodes (IDE). The pyridine carbon nanothreads were deposited on the IDE using a vacuum filtration and stamping process using the method of example 3, providing a large enough density of nanothreads for sensor performance. The IDE configuration enables effective electric contact between the pyridine carbon nanothreads and the electrodes over large areas while providing good accessibility for gas/vapor adsorption to all pyridine carbon nanothreads. This relatively simple fabrication is important to developing inexpensive sensor systems. The IDE chips are based on a 5 mm×8 mm×0.52 mm P-type monocrystalline Si/SiO₂ wafer, and the contact electrodes are made up of Cr/Au and line spacing is indicated in FIG. 7(a). The suitable temperature for using these IDEs is from −100 degrees Celsius to +500 degrees Celsius. These chips are suitable for use in biological, medical, chemical, and optical sensors.

The fabricated devices were placed on a microprocessor holder as presented in the picture in FIG. 7(b). The sensor devices were exposed to acetone and ethanol at different concentrations to demonstrate sensor performance. The acetone and ethanol were inundated with argon in a glass bubbler and carried through to an outlet nozzle positioned on top of the sensing devices as shown in the picture in FIG. 7(c). The normalized electrical resistance in the presence of different gas vapors was measured. The normalized resistance was plotted which is defined by R_{N}═(R−R₀)/R₀, in which R represents the electrical resistance obtained in the measurement; R₀ is the mean value of the resistance. In the ethanol sensor experiments, 3 cycles have been chosen, allowing 120 s of solvent vapor to flow through the outlet nozzle, and 120 s for purging the system with pure Ar. In the acetone sensor experiments, 5 cycles have been chosen, allowing 60 s of solvent vapor to flow through the outlet nozzle, and 60 s for purging the system with pure Ar.

FIG. 7(d) depicts the normalized electrical resistance versus time plot for a sensor based on pyridine carbon nanothreads in the presence of ethanol vapor. The resistance increases significantly upon exposure to ethanol. The response time to both ethanol exposure and argon purging is less than one second. The fast response suggest that ethanol molecules do not chemically bond to the carbon nanothreads. From these results, it can be concluded that pyridine carbon nanothreads are suitable for sensing ethanol in a reversible way exhibiting a very fast response time.

FIG. 7(e) depicts the normalized electrical resistance versus time plot for a sensor based on pyridine carbon nanothreads in the presence of acetone vapor. The resistance increases significantly upon exposure to acetone. The response time to both acetone exposure and argon purging is less than one second. The fast response suggest that acetone molecules also do not chemically bond to the carbon nanothreads. From these results, it can be concluded that pyridine carbon nanothreads are suitable for sensing acetone in a reversible way exhibiting a very fast response time.

There is a significance difference between the resistance increase of the pyridine carbon nanothread sensors when exposed to ethanol compared to acetone, indicating a certain degree of sensing selectivity.

### Example 5: Determination of Photo Detection Activity/Properties of Pyridine Carbon Nanothreads

With a tuneable band gap of 2-4 eV carbon nitride materials such as pyridine carbon nanothreads have potential applications to the sensitive detection of light signals in the ultraviolet (UV) and near-UV range.^{20,21} Zinc oxide nanowires (ZnO) which exhibit a 3.3 eV band gap are the material of choice in UV photodetectors.²² However, a major drawback of ZnO nanowires is that they can only work in the presence of oxygen and the morphology of ZnO is vulnerable to chemical corrosion during device fabrication. Carbon nanothreads have a tuneable band of 2-4 eV, they do not require the presence of oxygen to generate a photocurrent and they are chemically stable in most solvents, making them an alternative to ZnO in UV photodetectors.

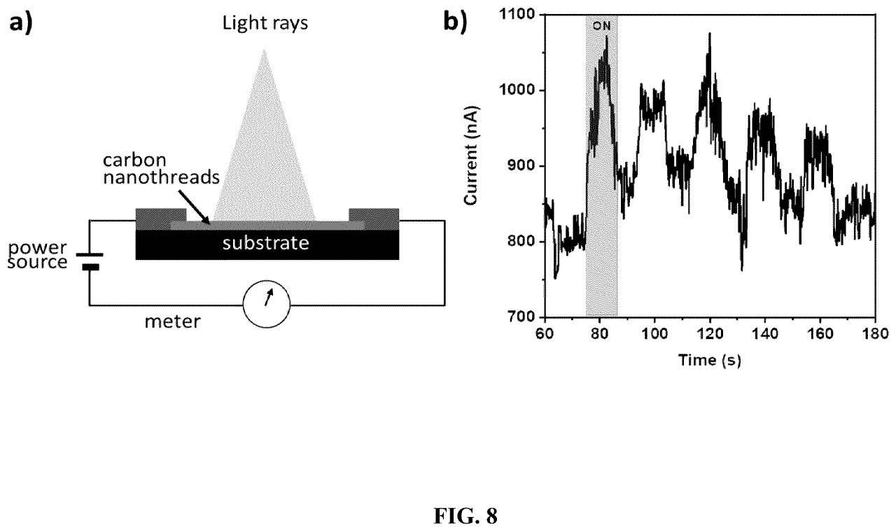

In this example, a simple pyridine carbon nanothread film-based photodetector device is demonstrated. The photosensitive material consists of exfoliated small bundles and individualized pyridine carbon nanothreads prepared using the method of example 2a and deposited using the method of example 3. In this platform, pyridine carbon nanothreads form a network on interdigitated electrodes (IDE) prepared using the same method of example 4. The cross-section representation of the pyridine carbon nanothread-based photodetector is presented in FIG. 8(a). To investigate the near-UV induced photocurrents in photodetectors, the time dependent response of the sample was tested by periodically switching on and off the incident beam (10 s period) under zero bias voltages. A Keithley 2400 source meter unit (voltage source and I-V measurements) were connected in series with the tested sample. The photocurrent response of the pyridine carbon nanothread photodetector was evaluated using a 405 nm laser illumination under ambient conditions.

The temporal photocurrent response for several on/off illumination cycles is shown in FIG. 8(b). When the near-UV beam was turned on or off, the current underwent an initial jump and then a gradual change to a steady state. The current increase cannot be explained by the pyridine carbon nanothread sample heating since a slow current change would be observed if heating was the cause of the increase. The time intervals of the illuminated and dark state are both 10 s. A positive current was produced by near-UV irradiation. In the pyridine carbon nanothread-based photodetector, the pyridine carbon nanothread film is working as the active material that converts light into a temporal photocurrent. The generation process of this photocurrent can be considered as that the carriers in the pyridine carbon nanothreads are excited under the near-UV illumination. The excess of electrons and holes lead to higher conductivity, and thus generate photocurrent in the pyridine carbon nanothread-based photodetector.

This demonstrates that pyridine carbon nanothreads are capable of absorbing near UV light and generating a photocurrent. This phenomenon can be employed to develop a new type of UV photodetector based on the unique photophysical properties of pyridine carbon nanothreads and the possibility to easily tune the band gap by varying heteroatom type and/or concentration.

It should be understood that modifications to the embodiments disclosed herein is made to meet a particular set of design criteria. Therefore, while certain exemplary embodiments of the dispersions, compounds, and methods of making and using the same have been discussed and illustrated herein, it is to be distinctly understood that the invention is not limited thereto but may be otherwise variously embodied and practiced within the scope of the following claims.

It will be apparent to those skilled in the art that numerous modifications and variations of the described examples and embodiments are possible in light of the above teachings of the disclosure. The disclosed examples and embodiments are presented for purposes of illustration only. Other alternate embodiments may include some or all of the features disclosed herein. Therefore, it is the intent to cover all such modifications and alternate embodiments as may come within the true scope of this invention, which is to be given the full breadth thereof. Additionally, the disclosure of a range of values is a disclosure of every numerical value within that range, including the end points.

### REFERENCES

The following references are each relied upon and incorporated herein in their entirety. Where information specifically stated in this specification can be construed to contradict anything in the incorporated material, the information specifically stated in this specification shall control.
1. Fitzgibbons, T. C. et al. Benzene-derived carbon nanothreads. Nat. Mater. 14, 43-47 (2015).
2. Huang, H. T. et al. Nanoarchitecture through Strained Molecules: Cubane-Derived Scaffolds and the Smallest Carbon Nanothreads. J. Am. Chem. Soc. 142, 17944-17955 (2020).
3. Wang, T. et al. Constraining Carbon Nanothread Structures by Experimental and Calculated Nuclear Magnetic Resonance Spectra. Nano Lett. 18, 4934-4942 (2018).
4. Demingos, P. G. & Muniz, A. R. Electronic and Mechanical Properties of Partially Saturated Carbon and Carbon Nitride Nanothreads. J Phys. Chem. C 123, 3886-3891 (2019).
5. Xu, X. et al. Ultrafast growth of single-crystal graphene assisted by a continuous oxygen supply. Nat. Nanotechnol. 11, 1-13 (2016).
6. Demingos, P. G., Balzaretti, N. M. & Muniz, A. R. First-principles study of carbon nanothreads derived from five-membered heterocyclic rings: thiophene, furan and pyrrole. Phys. Chem. Chem. Phys. 23, 2055-2062 (2021).
7. Tang, W. S. & Strobel, T. A. Evidence for Functionalized Carbon Nanothreads from π-Stacked, para-Disubstituted Benzenes. J. Phys. Chem. C 124, 25062-25070 (2020).
8. Huss, S. et al. Scalable Synthesis of Crystalline One-Dimensional Carbon Nanothreads through Modest-Pressure Polymerization of Furan. ACS Nano 15, 4134-4143 (2021).
9. Li, X. et al. Carbon nitride nanothread crystals derived from pyridine. J. Am. Chem. Soc. 140, 4969-4972 (2018).
10. Zhang, L. W., Ji, W. M. & Liew, K. M. Mechanical properties of diamond nanothread reinforced polymer composites. Carbon N. Y. 132, 232-240 (2018).
11. Zhan, H., Zhang, G., Tan, V. B. C. & Gu, Y. The best features of diamond nanothread for nanofibre applications. Nat. Commun. 8, 1-8 (2017).
12. Zhan, H., Zhang, G., Bell, J. M., Tan, V. B. C. & Gu, Y. High density mechanical energy storage with carbon nanothread bundle. Nat. Commun. 11, 1-11 (2020).
13. Zhan, H. et al. From brittle to ductile: A structure dependent ductility of diamond nanothread. Nanoscale 8, 11177-11184 (2016).
14. Fanetti, S., Santoro, M., Alabarse, F., Enrico, B. & Bini, R. Modulating the H-bond strength by varying the temperature for the high pressure synthesis of nitrogen rich carbon nanothreads. Nanoscale 12, 5233-5242 (2020).
15. Li, X. et al. Mechanochemical Synthesis of Carbon Nanothread Single Crystals. J. Am. Chem. Soc. 139, 16343-16349 (2017).
16. Roman, R. E., Kwan, K. & Cranford, S. W. Mechanical properties and defect sensitivity of diamond nanothreads. Nano Lett. 15, 1585-1590 (2015).
17. Zhan, H., Zhang, G., Bell, J. M. & Gu, Y. The morphology and temperature dependent tensile properties of diamond nanothreads. Carbon N. Y. 107, 304-309 (2016).
18. Sukumaran, S. S., Tripathi, S., Resmi, A. N., Gopchandran, K. G. & Jinesh, K. B. Influence of surfactants on the electronic properties of liquid-phase exfoliated graphene. Mater. Sci. Eng. B Solid-State Mater. Adv. Technol. 240, 62-68 (2019).
19. Gomez, C. V. et al. Preparation of few-layer graphene dispersions from hydrothermally expanded graphite. Appl. Sci. 9, (2019).
20. Gan, X., Lv, R., Zhang, T., Zhang, F. & Terrones, M. Transferrable polymeric carbon nitride/nitrogen-doped graphene films for solid state optoelectronics. Carbon N. Y. 138, 69-75 (2018).
21. Kessler, F. K. et al. Functional carbon nitride materials—design strategies for electrochemical devices. (2017) doi:10.1038/natrevmats.2017.30.
22. Soci, C. et al. ZnO Nanowire UV Photodetectors with High Internal Gain. 1-7 (2007).

1. A method for preparing a dispersion of carbon nanothreads in polar aprotic organic solvents, the method comprising the following steps:
(a) providing a carbon nanothread alkali metal compound, made up of carbon nanothreads with alkali metals intercalated in between the carbon nanothreads; and
(b) adding an organic polar aprotic solvent (A) or a mixture (A′) of polar aprotic solvents under anhydrous inert atmosphere to the carbon nanothread alkali metal compound of step (a).

2. The method according to claim 1, wherein:
step (b) is performed in the absence of sonication; or
step (b) generates a dispersion comprising a dispersed/dissolved phase of exfoliated reduced carbon nanothreads with positive counterions.

3. (canceled)

4. The method according to claim 2, further comprising:
generating a meta-stable organic dispersion of carbon nanothreads by exposing the dispersion of step (b) to air or oxygen to neutralize the reduced carbon nanothreads; or
generating a meta-stable organic dispersion of carbon nanothreads by exposing the dispersion of step (b) to air or oxygen to neutralize the reduced carbon nanothreads, and;
(d) mixing the meta-stable organic dispersion of neutralized exfoliated carbon nanothreads with a predetermined amount of water, or ionic aqueous solution; and
(e) evaporating the organic polar aprotic solvent (A) or the mixture (A′) of polar aprotic solvents to generate an air stable dispersion of carbon nanothreads in water.

5. The method according to claim 1, wherein:
the carbon nanothreads include nanothreads containing no heteroatoms or nanothreads containing N, B, S, Se, O, S, Si, or P heteroatoms in the carbon nanothread backbone; or
the carbon nanothreads contain N, B, S, Se, O, S, Si, or P heteroatoms in the carbon nanothread backbone; or
the carbon nanothreads contain organic and organometallic functional groups attached to the carbon nanothread backbone; or
the polar organic solvent is tetrahydrofuran, sulfolane, dimethyl sulfoxide, dimethylformamide, N-methylpyrrolidone, N-methylformamide, acetone, acetonitrile, dichloromethane, dimethylformamide, dimethylpropyleneurea, ethyl acetate, or hexamethylphosphoric triamide; or
the method involves preparing a dispersion of individualized and small bundles of carbon nanothreads.

6. (canceled)

7. The method according to claim 1, further comprising:
preparing the carbon nanothread alkali metal compound provided in step (a) by:
(i) reduction of carbon nanothreads by an alkali metal in vapor or molten phase;
(ii) reduction of carbon nanothreads by an alkali metal salt of formula M⁺B⁻, wherein M⁺ represents an alkali metal cation, and wherein the alkali metal is selected from lithium, sodium, potassium, rubidium or cesium; and B⁻ represents polyaromatic hydrocarbon; or
(iii) electrochemical reduction of carbon nanothreads.

8. A method of preparing a carbon nanothread alkali metal compound, the method comprising:
(i) reduction of carbon nanothreads by an alkali metal in vapor or molten phase;
(ii) reduction of carbon nanothreads by an alkali metal salt of formula M⁺B⁻, wherein M⁺ represents an alkali metal cation, and wherein the alkali metal is selected from lithium, sodium, potassium, rubidium or cesium; and B⁻ represents polyaromatic hydrocarbon; or
(iii) electrochemical reduction of carbon nanothreads.

9. A method of preparing a solution/dispersion of exfoliated reduced carbon nanothreads in a polar aprotic organic solvent, the method comprising:
adding an organic polar aprotic solvent (A) or a mixture (A′) of polar aprotic solvents under anhydrous inert atmosphere to a carbon nanothread alkali metal compound.

10. A method of preparing a dispersion of exfoliated carbon nanothreads in polar aprotic organic solvent, the method comprising:
exposing dispersions carbon nanothreads to air or oxygen to neutralize reduced carbon nanothreads to generate meta-stable organic dispersions of carbon nanothreads.

11. (canceled)

12. The method according to claim 4, wherein:
the organic polar aprotic solvent (A) or the mixture (A′) of organic polar aprotic solvents is fully or partially water miscible; or
the method involves preparing a homogeneous dispersion of carbon nanothreads in water.

13. (canceled)

14. (canceled)

15. A method for preparing a composite material, the method comprising:
preparing a dispersions of carbon nanothreads in in polar aprotic organic solvents in accordance with claim 1; and
generating a composite material from the dispersion of carbon nanothreads.

16. A method for preparing a composite material, the method comprising:
preparing a dispersion of carbon nanothreads in in polar aprotic organic solvents in accordance with claim 1; and
generating a composite material from the dispersion of carbon nanothreads;
wherein the composite material is obtained by:
mixing the dispersion of carbon nanothreads with a polymer solution or a polymer mixture solution; or
in situ polymerization of a monomer or mixture or monomers in the dispersion of carbon nanothreads.

17. The method according to claim 1, further comprising:
(i) freezing organic or aqueous dispersions of the dispersion of carbon nanothreads to generate a solvent of organic or aqueous dispersions; and
(ii) subliming the solvent of organic or aqueous dispersions to form an aerogel of carbon nanothreads.

18. (canceled)

19. (canceled)

20. The method according to claim 1, further comprising a step of functionalizing the carbon nanothread backbone or the ends of the carbon nanothreads.

21. The method of claim 2, wherein the polyaromatic hydrocarbon is naphthalene, benzophenone, fluorenone, or anthraquinone.

22. A method for producing a thin film on a substrate for an electronic device, the method comprising:
preparing a dispersion of carbon nanothreads in polar aprotic organic solvents in accordance with claim 1;
depositing the dispersion carbon nanothreads on a substrate.

23. The method according to claim 22, wherein:
depositing the dispersion of carbon nanothreads involves spin coating, drop-casting, vacuum filtration, plating, spray coating, chemical vapor deposition, or physical vapor deposition; or
the electronic device is a chemical sensor, a molecular sensor, or a photodetector.

24. (canceled)

25. A composition, comprising:
a dispersion having a dispersed/dissolved phase of exfoliated reduced carbon nanothreads with positive counterions.

26. The composition of claim 25, wherein:
the dispersion includes individualized and small bundles of carbon nanothreads; or
the carbon nanothreads contain N, B, S, Se, O, S, Si, or P heteroatoms in the carbon nanothread backbone; or
the carbon nanothreads contain organic and organometallic functional groups attached to the carbon nanothread backbone.

27. (canceled)

28. (canceled)

29. The composition of claim 25, wherein the composition is a composite material, an aerogel, or a thin film.

30. (canceled)

31. (canceled)
